(19) United States
(12) Patent Application Publication
(10) Pub. No.: US 2020/0314641 A1
(43) Pub. Date: Oct. 1, 2020

(54) RF SIGNATURE-BASED WIRELESS CLIENT IDENTIFICATION

(71) Applicant: Cisco Technology, Inc., San Jose, CA (US)

(72) Inventors: Claudius Samuel Tewari, San Jose, CA (US); Jagdish Girimaji, Pleasanton, CA (US); Matthew A. Silverman, Shaker Heights, OH (US); Jie C. Jiang, San Jose, CA (US); Hugo M. Latapie, Long Beach, CA (US); Enzo Fenoglio, Issy-les-Moulineaux (FR)

(73) Assignee: Cisco Technology, Inc.

(21) Appl. No.: 16/363,268

(22) Filed: Mar. 25, 2019

(51) Int. Cl. H04W 12/00; G06N 3/08; G06N 3/04; G06F 16/22

(52) U.S. Cl. CPC H04W 12/00524; G06N 3/08; G06N 3/04; H04W 84/12; G06F 16/2255; H04W 12/00512; H04W 12/0027

(57) ABSTRACT

In one embodiment, a device obtains radio frequency (RF) characteristic data for a wireless client. The device inputs the RF characteristic data for the wireless client to a deep learning-based encoder. The device learns a latent space representation of the RF characteristic data from the encoder. The device uses the learned latent space representation as a unique signature to identify the wireless client in a wireless network.

### TECHNICAL FIELD

The present disclosure relates generally to computer networks, and, more particularly, to radio frequency (RF) signature-based wireless device type identification.

### BACKGROUND

An emerging area of interest in the field of computer networking is the “Internet of Things” (IoT), which may be used by those in the art to refer to uniquely identifiable objects/things and their virtual representations in a network-based architecture. In particular, the next frontier in the evolution of the Internet is the ability to connect more than just computers and communications devices, but rather the ability to connect “objects” in general, such as lights, appliances, vehicles, window shades and blinds, doors, locks, etc.

As more non-traditional devices join the IoT, networks may eventually evolve from a bring-your-own-device (BYOD) model to a model that enables bring-your-own-thing (BYOT), bring-your-own-interface (BYOI), and/or bring-your-own-service (BYOS) paradigms. In other words, as the IoT grows, the number of available services, etc., will also grow considerably. For example, a single person in the future may transport sensor-equipped clothing, other portable electronic devices (e.g., cell phones, etc.), cameras, pedometers, or the like, into an enterprise environment, each of which may attempt to access the wealth of new IoT services that are available on the network.

From a networking perspective, the network can automatically configure access control policies, other security policies, and the like, if the identity of a particular client/device is known. For example, one policy may prevent an IoT temperature sensor from communicating with certain websites. In addition, device identification is important to ensure that a malicious actor is not impersonating a particular wireless client on the network. For example, a malicious entity may spoof the identity of the temperature sensor, to trigger unwanted actions by the heating, ventilation, and air conditioning (HVAC) system of the building.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example wireless network;

FIG. 4 illustrates an example architecture for generating a signature for a wireless client of a wireless network; and

FIG. 5 illustrates an example simplified procedure for using a signature to uniquely identify a wireless client in a wireless network.

### DESCRIPTION OF EXAMPLE EMBODIMENTS

### Overview

According to one or more embodiments of the disclosure, a device obtains radio frequency (RF) characteristic data for a wireless client. The device inputs the RF characteristic data for the wireless client to a deep learning-based encoder. The device learns a latent space representation of the RF characteristic data from the encoder. The device uses the learned latent space representation as a unique signature to identify the wireless client in a wireless network.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global io communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. lA is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

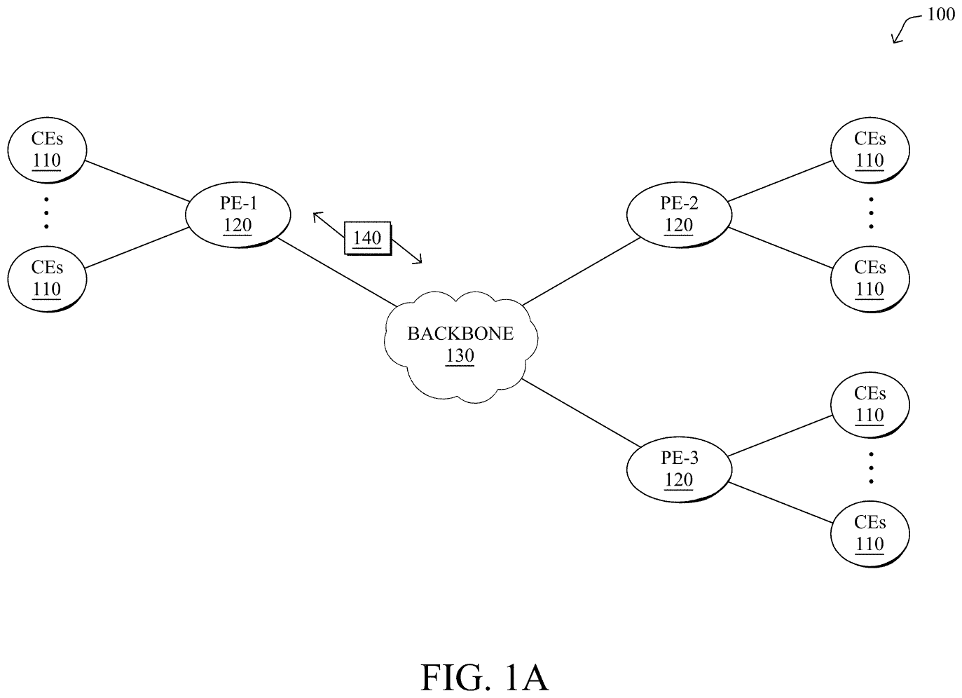

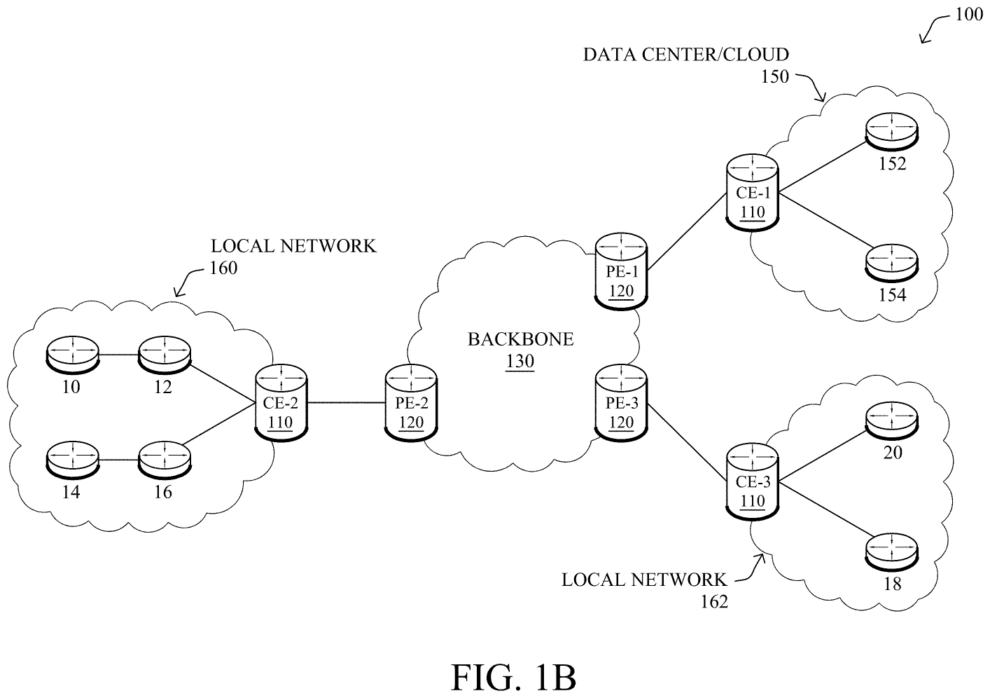

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather is the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or io humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically is support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

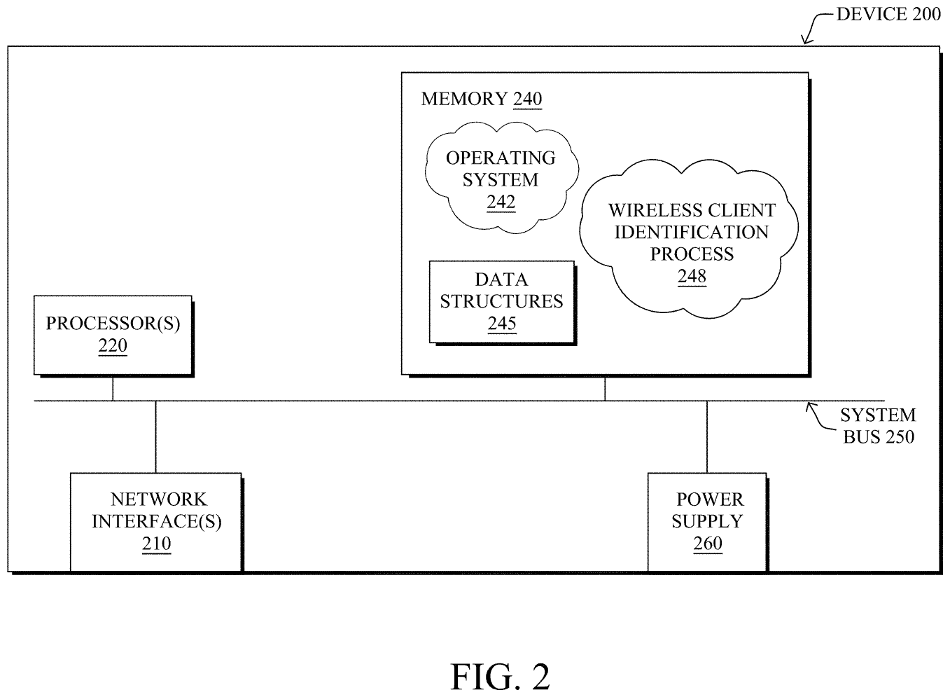

FIG. 2 is a schematic block diagram of an example computing device/node 200 that may be used with one or more embodiments described herein e.g., as any of the devices shown in FIG. 1 above or any of the devices described further below. The device may comprise one or more network interfaces 210 (e.g., wired, wireless, cellular, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network 100. The network interfaces may be configured to transmit and/or receive data using a variety of different communication protocols. Note, further, that the nodes may have two or more different types of network connections 210, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes io and/or services executing on the device. These software processes and/or services may comprise an illustrative wireless client identification process 248, as described herein.

It will be apparent to those skilled in the art that other processor and memory types, including various computer-readable media, may be used to store and execute program instructions pertaining to the techniques described herein. Also, while the is description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various embodiments, wireless client identification process 248 may utilize machine learning techniques, as described in greater detail below, to identify the device type of a wireless client based on its RF signature. In general, machine learning is concerned with the design and the development of techniques that take as input empirical data (such as network statistics and performance indicators) and recognize complex patterns in these data. One very common pattern among machine learning techniques is the use of an underlying model M, whose hyper-parameters are optimized for minimizing the cost function associated to M, given the input data. The learning process then operates by adjusting the hyper-parameters such that the number of misclassified points is minimal. After this optimization phase (or learning phase), the model M can be used very easily to classify new data points. Often, M is a statistical model, and the minimization of the cost function is equivalent to the maximization of the likelihood function, given the input data.

In various embodiments, wireless client identification process 248 may employ one or more supervised, unsupervised, or semi-supervised machine learning models. Generally, supervised learning entails the use of a training set of data, as noted above, that is used to train the model to apply labels to the input data. For example, the training data may include sample sets of captured RF signature data labeled with the device types of the devices that generated the RF signatures. On the other end of the spectrum are unsupervised techniques that do not require a training set of labels. Semi-supervised learning models take a middle ground approach that uses a greatly reduced set of labeled training data.

Example machine learning techniques that wireless client identification process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like. Accordingly, wireless client identification process 248 may employ deep learning, in some embodiments. Generally, deep learning is a subset of machine learning that employs ANNs with multiple layers, with a given layer learning features or transforming the outputs of the prior layer.

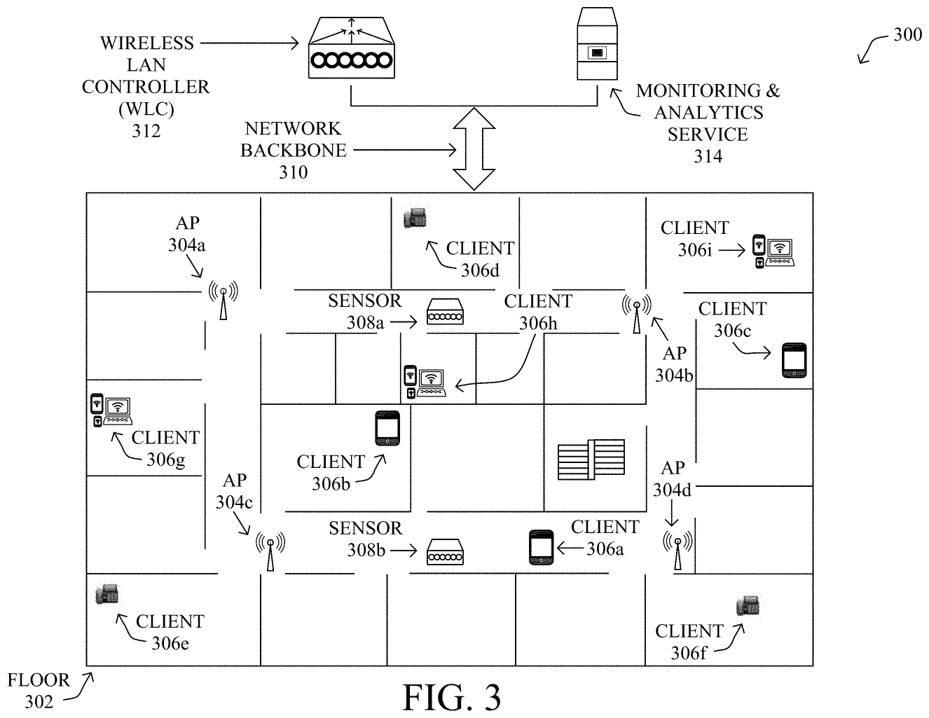

FIG. 3 illustrates an example wireless network 300, according to various embodiments. Wireless network 300 may be deployed to a physical location, such as floor 302 shown, and may include various infrastructure devices. These infrastructure devices may include, for example, one or more access points (APs) 304 that provide wireless connectivity to the various wireless clients 306 distributed throughout the location. For illustrative purposes, APs 304a-304d and clients 306a-306i are depicted in FIG. 3. However, as would be appreciated, a wireless network deployment may include any number of APs and clients.

A network backbone 310 may interconnect APs 304 and provide a connection between APs 304 and any number of supervisory devices or services that provide control over APs 304. For example, as shown, a wireless LAN controller (WLC) 312 may control some or all of APs 304a-404d, by setting their control parameters (e.g., max number of attached clients, channels used, wireless modes, etc.). Another supervisory io service that oversees wireless network 300 may be a monitoring and analytics service 314 that measures and monitors the performance of wireless network 300 and, if so configured, may also adjust the operation of wireless network 300 based on the monitored performance (e.g., via WLC 312, etc.). Note that service 314 may be implemented directly on WLC 312 or may operate in conjunction therewith, in various is implementations.

Network backbone 310 may further provide connectivity between the infrastructure of the local network and a larger network, such as the Internet, a Multiprotocol Label Switching (MPLS) network, or the like. Accordingly, WLC 312 and/or monitoring and analytics service 314 may be located on the same local network as APs 304 or, alternatively, may be located remotely, such as in a remote datacenter, in the cloud, etc. To provide such connectivity, network backbone 310 may include any number of wired connections (e.g., Ethernet, optical, etc.) and/or wireless connections (e.g., cellular, etc.), as well as any number of networking devices (e.g., routers, switches, etc.).

In some embodiments, wireless network 300 may also include any number of wireless network sensors 308, such as sensors 308a-308b shown. In general, “wireless network sensors” are specialized devices that are able to act as wireless clients and perform testing on wireless network 300 and are not to be confused with other forms of sensors that may be distributed throughout a wireless network, such as motion sensors, temperature sensors, etc. In some cases, an AP 304 can also act as a wireless network sensor, by emulating a client in the network for purposes of testing communications with other APs. Thus, emulation points in network 300 may include dedicated wireless network sensors 308 and/or APs 304, if so configured.

During operation, the purpose of an emulation point in network 300 is to act as a wireless client and perform tests that include connectivity, performance, and/or negative scenarios, and report back on the network behavior to monitoring and analytics service 314. In turn, service 314 may perform analytics on the obtained performance metrics, to identify potential network issues before they are reported by actual clients. If such an io issue is identified, service 314 can then take corrective measures, such as changing the operation of network 300 and/or reporting the potential issue to a network administrator or technician.

The types and configurations of clients 304 in network 300 can vary greatly. For example, clients 306a-306c may be mobile phones, clients 306d-306f may be office phones, and clients 306g-306i may be computers, all of which may be of different makes, models, and/or configurations (e.g., firmware or software versions, chipsets, etc.). Consequently, each of clients 306a-306i may behave very differently in wireless network 300 from both RF and traffic perspectives.

As noted above, the number of different device types on a typical network is ever increasing, as the IoT expands. Accordingly, in various embodiments, another potential function of monitoring and analytics service 314 may be to provide security functions to wireless network 300. In some embodiments, monitoring and analytics service 314 may apply different security policies to clients 306, depending on their corresponding device types. For example, a temperature sensor may be limited to communicating with its manufacturer's cloud service, whereas a mobile phone may be able to access most websites on the Internet. In addition, monitoring and analytics service 314 may be configured to verify the identity of the temperature sensor, so as to prevent device spoofing by a malicious actor.

Today, a wireless client is uniquely identify based on a single characteristic such as the MAC address of its wireless interface. However, this approach is becoming increasingly unsatisfactory, as MAC addresses can be spoofed. For example, a wireless device may maliciously claim to be a sensor when it is not. In a more restricted way, this challenge is also present when wireless clients randomize MAC addresses.

RF Signature-Based Wireless Client Identification

The techniques herein allow for the compressing, indexing, and retrieval of large volumes of unique signatures for wireless clients that can be used to verify device claims made by wireless clients, placement and :location of RF wireless clients, and the :like. In some aspects, deep learning can be used to analyze the RF characteristics of a wireless client, to learn a signature for the client. The deep signature learned in this way is a highly compressed representation of the original elementary signatures, which uniquely captures the high-level RF characteristics of the wireless client. Deep signature-based wireless device indexing and retrieval methods are also introduced herein for the placement and location of devices. For a large wireless device signatures database, the compressed signatures database can easily fit into the main memory of many devices, due to the small memory footprints of each composite deep signatures while maintaining the uniqueness of each signature.

Specifically, in some embodiments, a device obtains radio frequency (RF) characteristic data for a wireless client. The device inputs the RF characteristic data for the wireless client to a deep learning-based encoder. The device learns a latent space representation of the RF characteristic data from the encoder. The device uses the learned latent space representation as a unique signature to identify the wireless client in a wireless network.

Illustratively, the techniques described herein may be performed by hardware, software, and/or firmware, such as in accordance with the wireless client identification process 248, which may include computer executable instructions executed by the processor 220 (or independent processor of interfaces 210) to perform functions relating to the techniques described herein.

Operationally, the techniques herein introduce a method for a wireless device/client to be uniquely identified by a composite robust signature comprising any or all of the following information and not limited to the following RF characteristic data for the client: capability signature data, scanning signature data, physical (PHY) behavioral signature data, RF hardware signature data, etc.

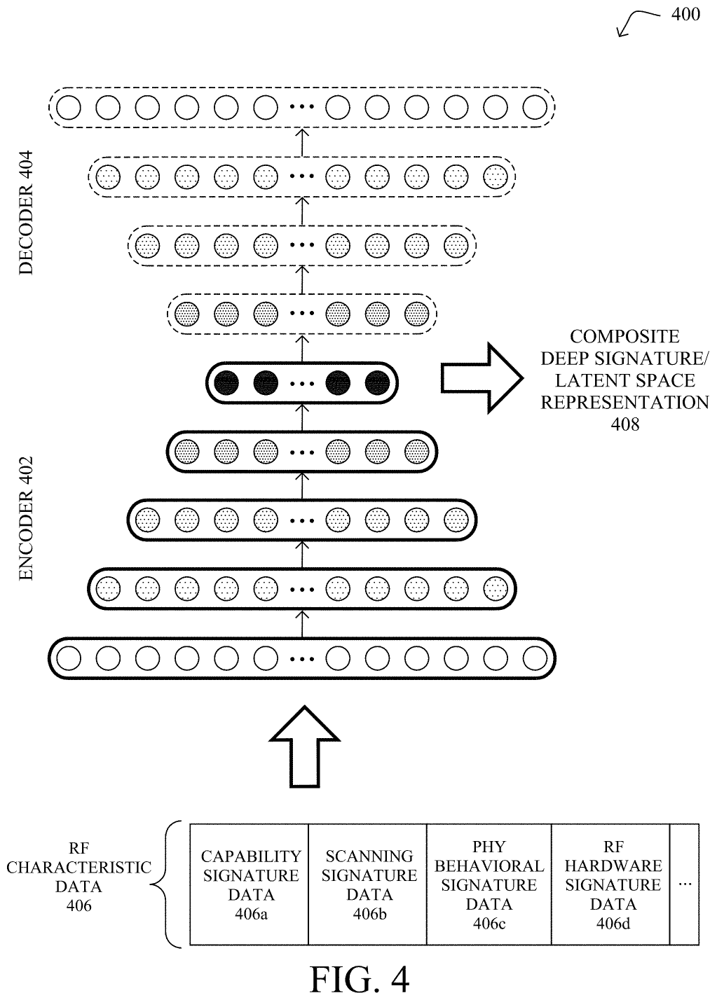

FIG. 4 illustrates an example architecture 400 for generating a signature for a wireless client of a wireless network, according to various embodiments. In general, architecture 400 may be implemented by a device (e.g., device 200 described previously) executing specialized instructions (e.g., wireless client identification process 248), to io provide a supervisory service to a wireless network (e.g., service 314 described previously or the like).

To generate a composite deep signature/latent space representation 408 for a given wireless client, the executing device may obtain any or all of the following RF characteristic data 406 regarding the wireless client:

Capability Signature Data 406a: The capability of the client is advertised during the connectivity phase of the client attempting to join a wireless network. These capabilities may be Information Elements present in the association request packet from the client. Examples of data 406a may include, but are not limited to, the following:
MAC randomization pattern
Vendor Tags
Number of supported spatial streams
Supported wireless protocol options, such as High Throughput (HT), Very High Throughput (VHT), High Efficiency (HE), antennal selection (ASEL) support, Low Density Parity Check (LDPC), Space Time Block Coding (STBC), etc.
Dual hand support 2.4 and 5 GHz)
Max aggregated MAC service data unit (AMSDU) size
Maximum MAC protocol data unit (MPDU) density support
Supported bandwidths (e.g., 160, 80+80, etc.)

Scanning Signature 406b—During the discovery phase of a wireless client searching for the presence of a wireless network, the client will use a unique, vendor-dependent algorithm to scan and probe for the wireless network. Examples of data 406b may include, but are not limited to, the following:
How long the device stays on each channel before the client associates
Which channels were visited by the client
The order of channels visited by the client

PHY Behavioral Signature Data 406c—The wireless client may also have different PHY capabilities, depending on the hardware implementation of the device. For example, a mobile phone may only support 2×2 chains (Tx/Rx) or only 2 spatial streams, whereas a laptop may support 3×3 chains. Examples of is data 406c may include, but are not limited to, the following:
Beamforming
PHY rate and Ng and compression used for explicit feedback
PHY rate used for Request to Send (RTS) frames
PHY rate used for Clear to Send (CTS) frames
PHY rate used for Block Acknowledgement (BA)
PHY Behavior of Block ACKs/RTS/CTS
BW used for NON_HT CTS or BA in response to a >20 MHz frame
Bitmap/sequence in BA_Indeed, some clients move the sequence number base every time an MPDU is successful, while others only update if required to represent the most advanced MPDU received
Multiple-Input and Multiple-Output (MIMO) information
Estimate of per-antenna, time-domain cyclic shift diversity used for 1, 2, 3, etc. spatial stream frames (for >1 Tx devices)
Estimate Spatial mapping for 1, 2, 3 . . . N spatial streams
Scrambler seed pattern (constant, +1, pseudorandom, etc.)

RE Hardware Signature Data 406d—The RE hardware of a wireless client will exhibit its unique signature. For example, data 406d may include, but is not limited to, the following:
Carrier frequency offset (CFO)
CFO patterns

According to various embodiments, the device may form the composite deep signature 408 for the wireless client by first concatenating the elementary signatures 406a, 406b, 406c, 406d, etc. for functionally different characteristics of the wireless client and using the concatenated RE characteristic data 406 as input to a deep learning-based encoder 402. In some embodiments, encoder 402 may be the first half of an autoencoder that also includes decoder 404, which can be used for any number of purposes, as desired.

As would be appreciated, autoencoders are a class of neural networks that use unsupervised learning to learn how to reconstruct an input dataset by first compressing the input data into what is known as its latent space representation. More specifically, the encoding path of an autoencoder, also known as its encoder compresses the input into a stochastic binary output in a non-linear manifold. In turn, the decoding path attempts to reconstruct the original input data from the latent space representation. For example, in the context of image processing, an autoencoder can be trained to reconstruct the full image of an object, even if the object is partially obstructed in the original image. For purposes of generating a unique signature for a wireless client, only the encoder half of an autoencoder and the resulting latent space representation is needed. However, a decoder can also be used for any number of other purposes, as desired.

In general, the latent space representation of the input to an autoencoder, also referred to as a deep signature, is a highly condensed representation of the device identity with a smaller memory footprint, yet still encoding high-level device unique identities. In some embodiments, the autoencoder (or simply encoder 402) may be set in the framework of minimum description length (MDL), i.e., data compression via a probabilistic generative model, using the general correspondence between compression and probability distributions on the elementary signatures (e.g., signature data 406a, 406b, etc.). The objective is then to minimize the codelength (log-likelihood) of the elementary signatures using the latent space composite signature learned by the autoencoder/encoder 402 that represents the composite deep signature of the wireless client.

The device implementing architecture 400 may learn the latent space representation of the RF characteristic data 406 from the output of encoder 402 as the composite deep signature 408 of the subject endpoint client. In turn, the device may store signature 408 in a database for use in the network. For example, the database may include a hash table lookup that allows for the quick retrieval and use of the signature for a particular wireless client.

In various embodiments, the resulting unique deep signature 408 for a wireless client can be used in the wireless network for purposes of verifying the identity of the wireless client. In one embodiment, the unique signature can be used to verify a device type claim made by a wireless client. For example, if the client claims to be a particular type of IoT sensor, such as via Manufacturer Usage Description (MUD) information, the signature of the client can be used to verify that it is indeed of the claimed type. In further embodiments, the signature can also be used to apply a security policy to the wireless client, such as by limiting which services or endpoints can communicate with the client, etc.

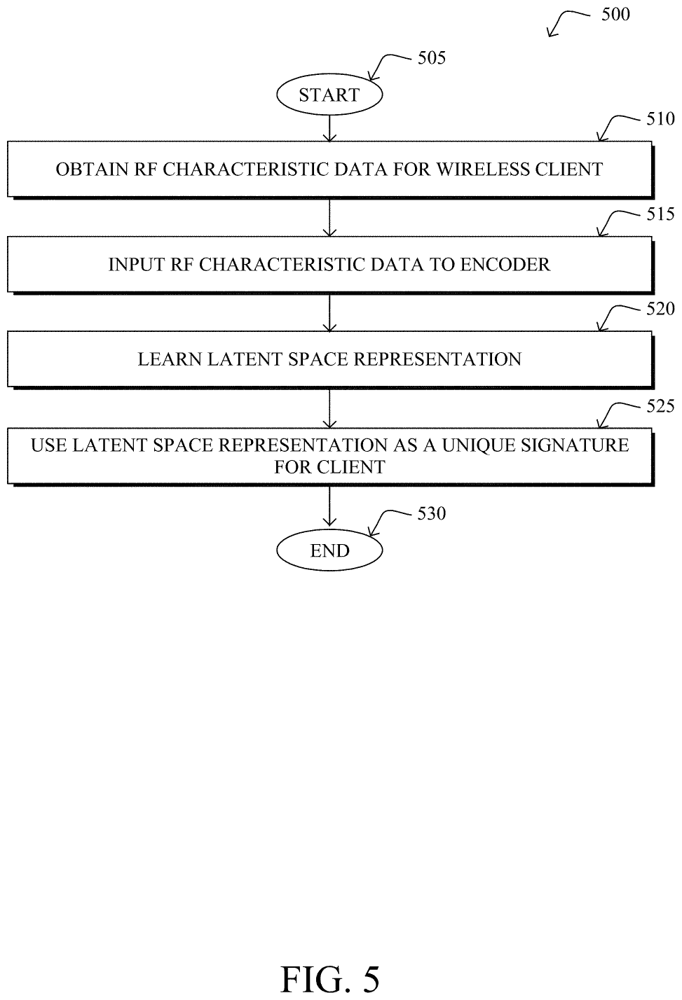

FIG. 5 illustrates an example simplified procedure for using a signature to uniquely identify a wireless client in a wireless network, in accordance with one or more embodiments described herein. For example, a non-generic, specifically configured device (e.g., device 200) may perform procedure 500 by executing stored instructions (e.g., process 248), to provide a supervisory service to a wireless network. The procedure 500 may start at step 505, and continues to step 510, where, as described in greater detail above, the device may obtain radio frequency (RF) characteristic data for a wireless client. For example, one or more APs in the wireless network may capture this information from packets sent by the wireless client to the network. In general, the RF characteristic data may be indicative of the wireless capabilities of the client, the scanning behavior of the client, the PHY behavior of the client, the RF signature of the client, or the like.

At step 515, as detailed above, the device may input the obtained RF characteristic data for the wireless client to a deep learning-based encoder. In some embodiments, the encoder may be part of a deep learning-based autoencoder, although the techniques herein can also be used with only an encoder.

At step 520, the device may learn a latent space representation of the RF is characteristic data from the encoder, as described in greater detail above. Notably, the encoder may be configured to generate a compressed representation of the RF characteristic data input to the encoder.

At step 525, as detailed above, the device may use the learned latent space representation as a unique signature to identify the wireless client in a wireless network. Typically, the latent space representation generated by an encoder is then used as input to the decoder portion of an autoencoder. However, the techniques herein propose using this compressed representation as a unique device signature for the wireless client. As would be appreciated, the compressed signature will be quite small in relation to the original input data, allowing the signature to have a minimal memory footprint. For example, the signature can be stored in a database that includes a hash table lookup, which can then be disseminated to any number of devices in the wireless network for any number of desired purposes. For example, the signature can be used to verify a device type claim made by a client in the network, to apply a security policy to the wireless client, or the like. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a mechanism for generating unique signature for wireless clients. In contrast to simply using the MAC addresses of the clients as their device signatures, the proposed signatures are nigh-impossible to spoof, as they are based on the actual hardware and wireless behaviors of the client. In further aspects, the signatures are also in a very compressed form, in comparison to their underly RF characteristic data, allowing for the efficient storage of potentially thousands of client signatures.

While there have been shown and described illustrative embodiments that provide is for RF signature-based wireless client identification in a network, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
obtaining, by a device, radio frequency (RF) characteristic data for a wireless client;
inputting, by the device, the RF characteristic data for the wireless client to a deep learning-based encoder;
learning, by the device, a latent space representation of the RF characteristic data from the encoder; and
using, by the device, the learned latent space representation as a unique signature to identify the wireless client in a wireless network.

2. The method as in claim 1, further comprising:
using the unique signature to verify a device type claim made by a wireless client in the wireless network.

3. The method as in claim 1, further comprising:
applying a security policy to the wireless client, based on the identification of the wireless client in the wireless network.

4. The method as in claim 1, wherein the RF characteristic data for the wireless client comprises one or more of: a media access control (MAC) randomization pattern, a maximum aggregated MAC service data unit (AMSDU), MAC protocol data unit (MPDU) density support, bandwidths supported by the client, or an indication of dual s band support.

5. The method as in claim 1, wherein the encoder is part of a deep learning-based autoencoder.

6. The method as in claim 1, wherein the RF characteristic data comprises a scanning and probing pattern used by the wireless client for network discovery.

7. The method as in claim 1, wherein the RF characteristic data comprises one or more of: a beamforming capability of the client, a physical layer (PHY) rate used by the client, a scrambler seed pattern of the client, or spatial stream information for the client.

8. The method as in claim 1, wherein the RF characteristic data comprises a carrier frequency offset (CFO) patterns of the client.

9. The method as in claim 1, further comprising:
storing the latent space representation in a device signature database that uses a hash table index.

10. An apparatus, comprising:
one or more network interfaces to communicate with a network;
a processor coupled to the network interfaces and configured to execute one or more processes; and
a memory configured to store a process executable by the processor, the process when executed configured to:
obtain radio frequency (RF) characteristic data for a wireless client;
input the RF characteristic data for the wireless client to a deep learning-based encoder;
learn a latent space representation of the RF characteristic data from the encoder; and
use the learned latent space representation as a unique signature to identify the wireless client in a wireless network.

11. The apparatus as in claim 10, wherein the process when executed is further configured to:
using the unique signature to verify a device type claim made by a wireless client in the wireless network.

12. The apparatus as in claim 10, wherein the process when executed is further configured to:
apply a security policy to the wireless client, based on the identification of the wireless client in the wireless network.

13. The apparatus as in claim 10, wherein the RF characteristic data for the wireless client comprises one or more of: a media access control (MAC) randomization pattern, a maximum aggregated MAC service data unit (AMSDU), MAC protocol data unit (MPDU) density support, bandwidths supported by the client, or an indication of dual band support.

14. The apparatus as in claim 10, wherein the encoder is part of a deep learning-based autoencoder.

15. The apparatus as in claim 10, wherein the RF characteristic data comprises a scanning and probing pattern used by the wireless client for network discovery.

16. The apparatus as in claim 10, wherein the RF characteristic data comprises one or more of: a beamforming capability of the client, a physical layer (PHY) rate used by the client, a scrambler seed pattern of the client, or spatial stream information for the client.

17. The apparatus as in claim 10, wherein the RF characteristic data comprises a carrier frequency offset (CFO) patterns of the client.

18. The apparatus as in claim 10, wherein the process when executed is further configured to:
storing the latent space representation in a device signature database that uses a hash table index.

19. A tangible, non-transitory, computer-readable medium storing program instructions that cause a device to execute a process comprising:
obtaining, by the device, radio frequency (RF) characteristic data for a wireless client;
inputting, by the device, the RF characteristic data for the wireless client to a deep learning-based encoder;
learning, by the device, a latent space representation of the RF characteristic data from the encoder; and
using, by the device, the learned latent space representation as a unique signature io to identify the wireless client in a wireless network.

20. The computer-readable medium as in claim 19, further comprising:
using the unique signature to verify a device type claim made by a wireless client in the wireless network.
